(19) United States
(12) Patent Application Publication
(10) Pub. No.: US 2017/0289062 A1
(43) Pub. Date: Oct. 5, 2017

(54) WORKLOAD DISTRIBUTION BASED ON SERVICEABILITY

(71) Applicant: LENOVO ENTERPRISE SOLUTIONS (SINGAPORE) PTE. LTD., Singapore (SG)

(72) Inventors: PAUL ARTMAN, CARY, NC (US); FRED A. BOWER, III, DURHAM, NC (US); GARY D. CUDAK, WAKE FOREST, NC (US); AJAY DHOLAKIA, CARY, NC (US); SCOTT KELSO, CARY, NC (US)

(21) Appl. No.: 15/084,135

(22) Filed: Mar. 29, 2016

(51) Int. Cl. H04L 12/911; H04L 29/08

(52) U.S. Cl. CPC H04L 47/822; H04L 67/18

(57) ABSTRACT

Workload distribution based on serviceability includes: generating, for each of a plurality of computing systems, a metric representing serviceability of the computing system for which the metric is generated; and distributing workload among said plurality of computing systems in dependence upon the metrics.

### BACKGROUND

### Field of the Invention

The field is data processing, or, more specifically, methods, apparatus, and products for workload distribution based on serviceability.

### Description Of Related Art

Data centers today may include many computing systems and may be located at various geographic locations. For example, one company may utilize data centers spread out across a country for co-location purposes. Local maintenance work on such computing systems, or components within the computing systems, may not equivalent in terms of time, cost or personnel. Some computing systems may be physically located high within a rack and require special equipment or particular service personnel to handle maintenance. Other computing systems may be more difficult to access due to the cabling system in place. Remote locations may also have travel costs associated with maintenance activity. Other locations may have reduced staff levels. These scenarios can lead to increased downtime and increased overall cost of ownership for some systems, over others, depending on the ease and risk of servicing coupled with the frequency of service need driven by elective usage patterns.

### SUMMARY

Methods, apparatus, and products for workload distribution based on serviceability are disclosed within this specification. Such workload distribution includes: generating, for each of a plurality of computing systems, a metric representing serviceability of the computing system for which the metric is generated; and distributing workload among said plurality of computing systems in dependence upon the metrics.

The foregoing and other features will be apparent from the following more particular descriptions of example embodiments as illustrated in the accompanying drawings wherein like reference numbers generally represent like parts of embodiments.

### BRIEF DESCRIPTION OF THE DRAWINGS

FIG. 1 sets forth a block diagram of an example system configured for workload distribution based on serviceability according to embodiments of the present disclosure.

FIG. 2 sets forth a flow chart illustrating an example method for workload distribution based on serviceability according to embodiments of the present disclosure.

FIG. 3 sets forth a flow chart illustrating another example method for workload distribution based on serviceability according to embodiments of the present disclosure.

FIG. 4 sets forth a flow chart illustrating another example method for workload distribution based on serviceability according to embodiments of the present disclosure.

FIG. 5 sets forth a flow chart illustrating another example method for workload distribution based on serviceability according to embodiments of the present disclosure.

FIG. 6 sets forth a flow chart illustrating another example method for workload distribution based on serviceability according to embodiments of the present disclosure.

FIG. 7 sets forth a flow chart illustrating another example method for workload distribution based on serviceability according to embodiments of the present disclosure.

### DETAILED DESCRIPTION

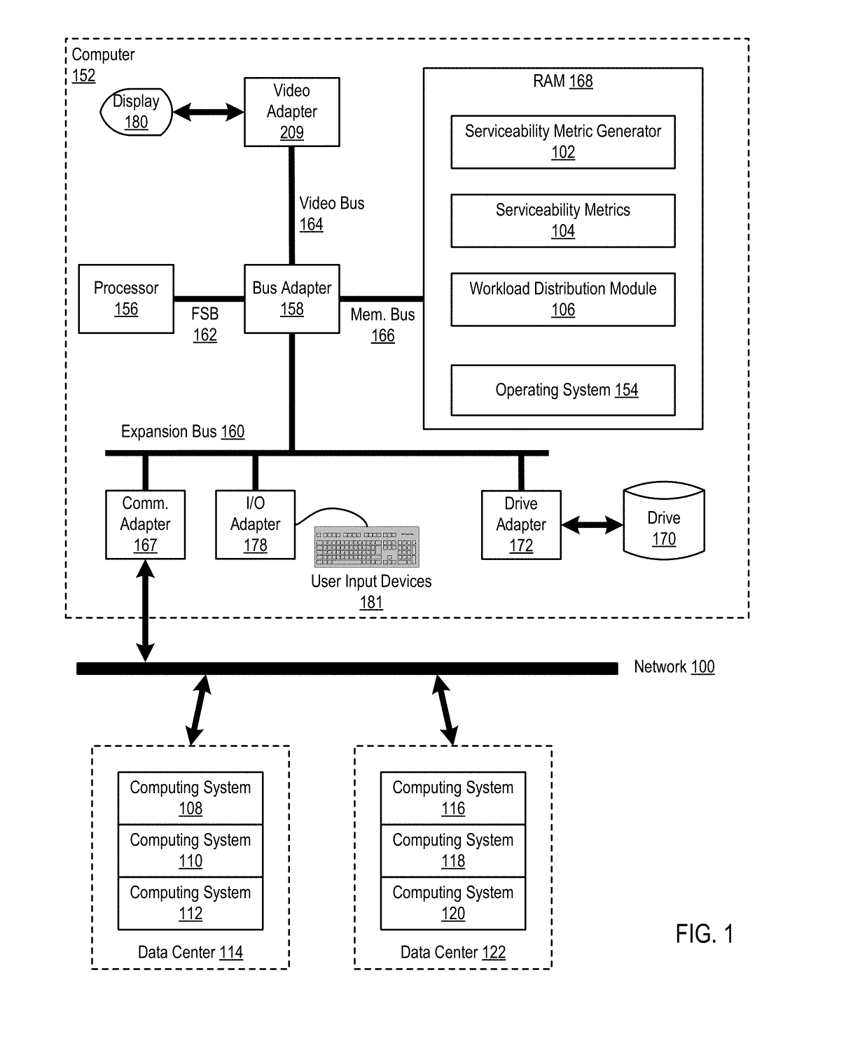

Exemplary methods, apparatus, and products for workload distribution based on serviceability in accordance with the present disclosure are described with reference to the accompanying drawings, beginning with FIG. 1. FIG. 1 sets forth a block diagram of an example system configured for workload distribution based on serviceability according to embodiments of the present disclosure.

The system of FIG. 1 includes an example of automated computing machinery in the form of a computer (152). The example computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a serviceability metric generator (102), a module of computer program instructions for generating a metric representing serviceability of a computing system. The term serviceability as used here refers to refers to the ability of technical support personnel to install, configure, and monitor computing systems, identify exceptions or faults, debug or isolate faults to root cause analysis, and provide hardware or software maintenance in pursuit of solving a problem or restoring the product into service. A serviceability metric is a value representing the serviceability of a computing system. In some embodiments, the serviceability metric may be expressed as a cost. In other embodiments, the serviceability metric may be a value between zero and 100, where numbers closer to 100 represent greater difficulty to service a computing system. Serviceability of computing systems may vary for many different reasons. Geographical location of a data center within which the computing system is installed, for example, may cause variations in serviceability. A computing system installed in a geographically remote data center, for example, may require greater technician travel, and thus cost, than a computing system installed within a local data center physically located nearer the technician's primary place of operation. In another example, computing systems located very high within a rack may be more difficult to service than computing systems at eye level. In yet another example, cabling may cause one computing system to be more difficult to service than another computing system. In yet another example, components within computing systems may vary in serviceability. One internal hard disk drive, for example, may be more difficult to service then a second within the same computing system due to the location of the disk drives within a computing system chassis. Some components may require more technician time to service than others.

To that end, the example serviceability metric generator (102) of FIG. 1 may be configured to generate, for each of a plurality of computing systems, a metric (104) representing serviceability of the computing system for which the metric is generated. In FIG. 1, for example, the serviceability metric generator (102) may generate a metric for each of the computing systems (108, 110, 112, 116, 118, 120) installed within two different data centers (114, 122).

Also stored in RAM (168) is a workload distribution module (106). The example workload distribution module is a module of computer program instructions that is configured to distribute workload across the computing systems (108, 110, 112, 116, 118, 120). Such a workload distribution module may perform ‘wear leveling’ in which, generally, workload is distributed in a manner to provide uniform usage of the computing systems. However, as noted above, some computing systems servicing some computing systems may be more difficult, time consuming, or costly than other computing systems. To that end, the wear leveling performed by the workload distribution module (106) in the example of FIG. 1 may take into account the serviceability metrics generated by the serviceability metric generator in determining workload distribution. That is, the workload distribution module (106) of FIG. 1 may distribute workload among the plurality of computing systems (108, 110, 112, 116, 118, 120) in dependence upon the serviceability metrics (104). Readers of skill in the art will recognize that although the serviceability metric generator (102) and the workload distribution module (106) are depicted as separate modules, such modules may also be implemented in a single application.

Also stored in RAM (168) is an operating system (154). Operating systems useful in computers configured for workload distribution based on serviceability according to embodiments of the present disclosure include UNIX™, Linux™, Microsoft Windows™, AIX™, IBM's iOS™, and others as will occur to those of skill in the art. The operating system (154), serviceability metric generator (102), and workload distribution module (106) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for workload distribution based on serviceability according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for workload distribution based on serviceability according to embodiments of the present disclosure include modems for wired dial-up communications, Ethernet (IEEE 802.3) adapters for wired data communications, and 802.11 adapters for wireless data communications.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present disclosure may be implemented on a variety of hardware platforms in addition to those illustrated in FIG. 1.

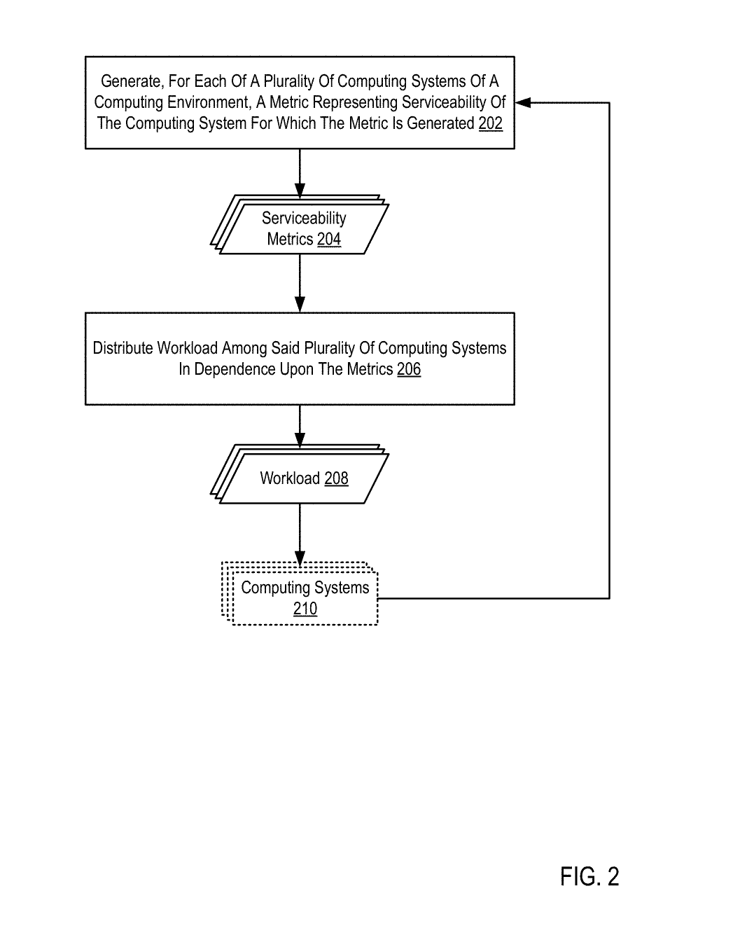

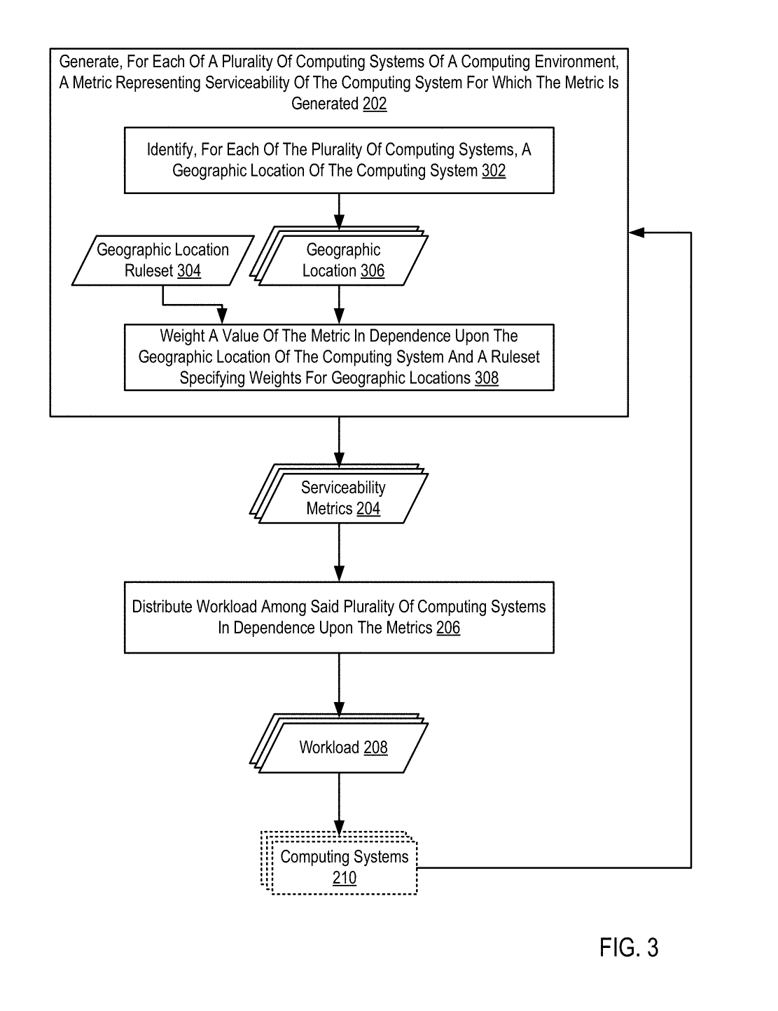

For further explanation, FIG. 2 sets forth a flow chart illustrating an example method for workload distribution based on serviceability according to embodiments of the present disclosure. The method of FIG. 2 includes generating (202), for each of a plurality of computing systems (210), a metric representing serviceability of the computing system for which the metric is generated. Generating (202) a serviceability metric (204) may be carried out in a variety of ways some of which are set forth below in FIGS. 3-7. Generally, generating (202) a serviceability metric for a computing system may be carried out by selecting a value representing ease of servicing a computing system based on a heuristic or ruleset defining such values. Such generation of serviceability metrics may be carried out periodically upon predefined intervals, dynamically at the behest of a user, or dynamically responsive to a change in the computing environment, such as the addition of a computing system to a rack.

The method of FIG. 2 also includes distributing (206) workload (208) among said plurality of computing systems (210) in dependence upon the metrics (204). Distributing (206) workload (208) among said plurality of computing systems (210) in dependence upon the metrics (204) may be carried out by selecting, for each workload, one or more of the plurality of computing systems (210) to perform the workload in a manner in which, over time and additional assignments, the workload is distributed to achieve uniform (or near uniform) serviceability. That is, computing systems with a serviceability metric that indicates a higher ease of serviceability (a lower cost of serviceability, for example), are more likely to be selected to perform workloads than computing systems with a serviceability metric that indicates a greater difficulty of serviceability. In such a manner, those computing systems which are more difficult to service (in terms of time, cost, impact of failure, and the like), are utilized less frequently and are thus less likely to present failures than computing systems that are less difficult to service.

For further explanation, FIG. 3 sets forth a flow chart illustrating another example method for workload distribution based on serviceability according to embodiments of the present disclosure. The method of FIG. 3 is similar to the method of FIG. 2 in that the method of FIG. 3 also includes generating (202), for each of a plurality of computing systems, a metric representing serviceability of the computing system for which the metric is generated; and distributing (206) workload among said plurality of computing systems in dependence upon the metrics.

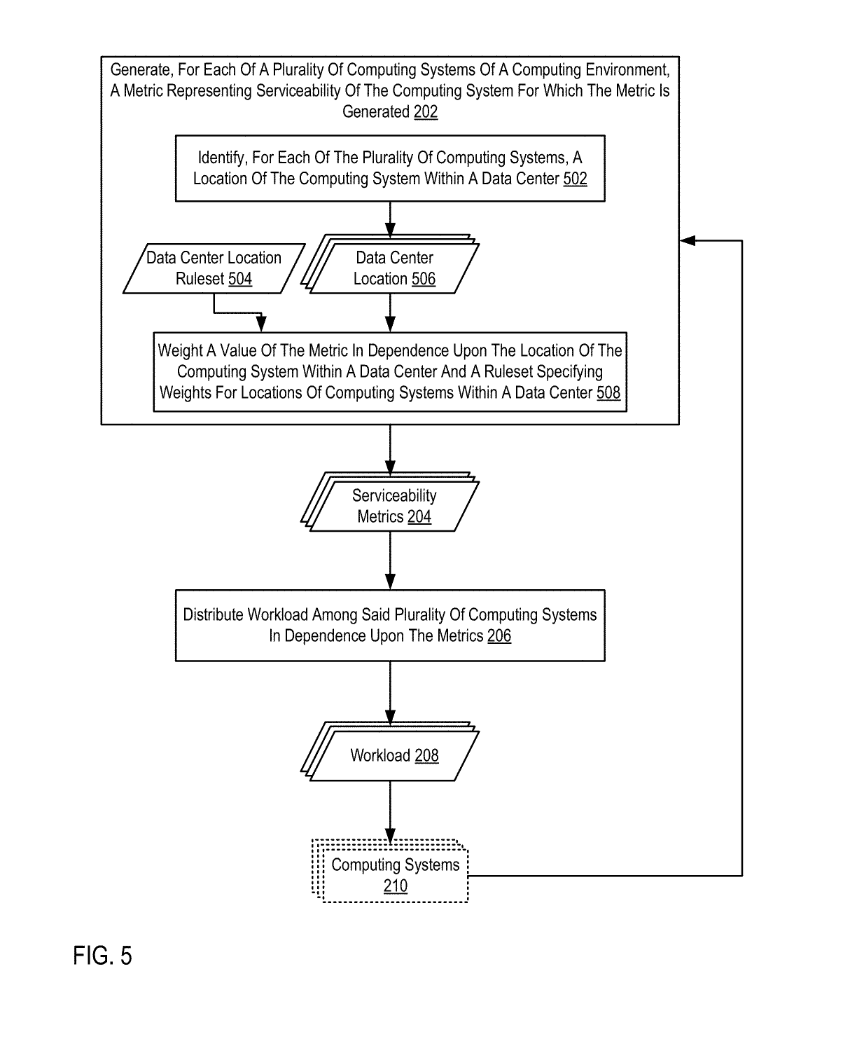

The method of FIG. 3 differs from the method of FIG. 2, however, in that in the method of FIG. 3 generating (202), for each of a plurality of computing systems, a metric representing serviceability of the computing system for which the metric is generated includes identifying (302), for each of the plurality of computing systems, a geographic location (306) of the computing system. Identifying (302), for each of the plurality of computing systems, a geographic location (306) of the computing system may be carried out in a variety of ways as set forth below in FIG. 5.

In the method of FIG. 3, generating (202) a metric representing serviceability also includes weighting (308) a value of the metric in dependence upon the geographic location (306) of the computing system and a ruleset (304) specifying weights for geographic locations. The ruleset (304) may generally specify values to assign to the metric or an amount by which to lower or increase for each of a plurality of ranges of distances. Such distances may, for example, represent the distance between the geographic location of the computing system and a place of operation of a technician. In such an example, the greater the distance the more the value of the metric may be altered. Consider, for example, a metric that begins as a value of one, which represents no difficulty in serviceability. The ruleset (304) may indicate the following:

TABLE 1
Geographic Location Ruleset

| Distance From Technician | Weighting |
|---|---|
| 0-10 miles | 10% |
| 11-20 miles | 20% |
| 21-30 miles | 30% |
| 31-40 miles | 40% |
| 41-50 miles | 50% |
| 51-60 miles | 60% |
| 61-70 miles | 70% |
| 71-80 miles | 80% |
| 81-90 miles | 90% |
| >90 miles | 100% |

Table 1 above includes two columns. A first column sets forth distances that a computing device is located from a technician. The second column is a weight to apply to a metric value based on the corresponding distance. For a computing system that is located 22 miles from the technician, the geographic location ruleset specifies a reduction of the serviceability metric by 30%. Thus, a serviceability metric of 0.7 may be generated for such a computing system.

Readers of skill in the art will recognize that such a ruleset may be implemented in a variety of manners. The ruleset may for example specify particular value to assign as the metric rather than percentages by which to increase or decrease the metric. As another example, the ruleset (304) may also specify cities or states rather than ranges of distances. Any ruleset that provides a means to vary the metric of a computing system based on that computing system's geographic location is well within the scope of the present disclosure.

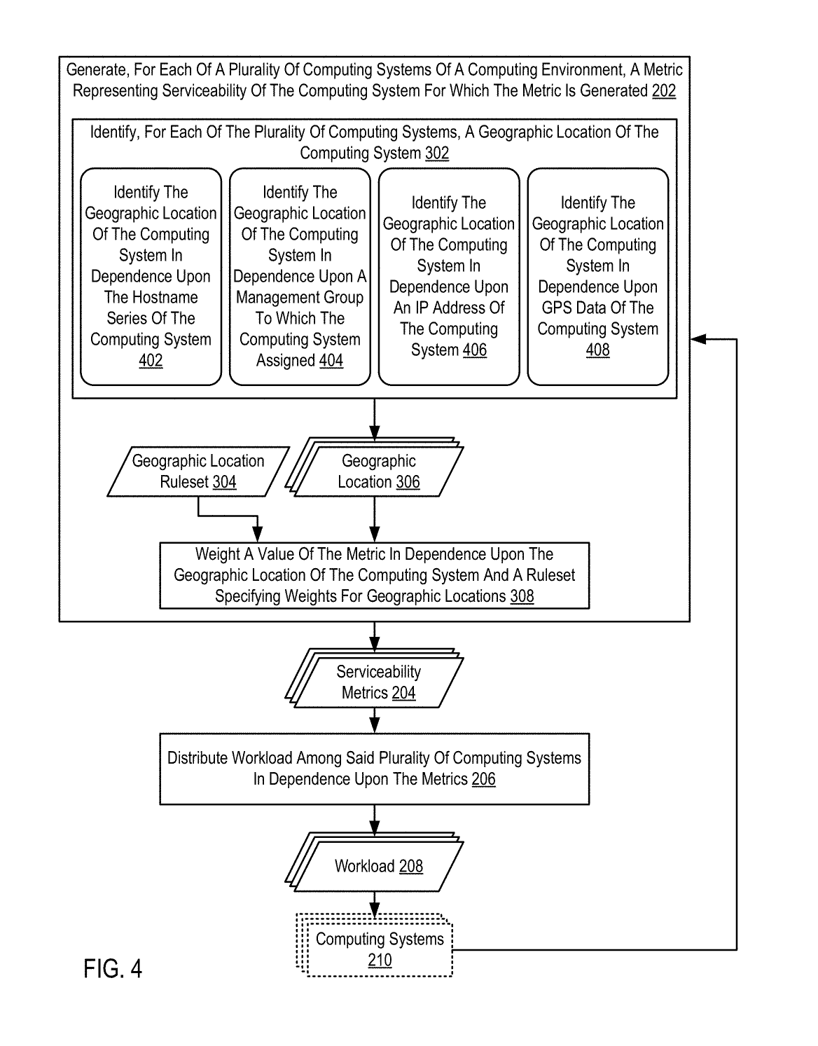

For further explanation, FIG. 4 sets forth a flow chart illustrating another example method for workload distribution based on serviceability according to embodiments of the present disclosure. The method of FIG. 4 is similar to the method of FIG. 3 in that the method of FIG. 4 also includes generating (202), for each of a plurality of computing systems, a metric representing serviceability of the computing system for which the metric is generated; and distributing (206) workload among said plurality of computing systems in dependence upon the metrics, where generating the serviceability metrics includes identifying (302), for each of the plurality of computing systems, a geographic location of the computing system and weighting (308) a value of the metric in dependence upon the geographic location of the computing system and a ruleset specifying weights for geographic locations.

The method of FIG. 4 differs from the method of FIG. 3, however, in that in the method of FIG. 4 sets forth several methods of identifying (302), for each of the plurality of computing systems, a geographic location of the computing system. In the method of FIG. 4, for example, identifying (302) a geographic location of a computing system may include identifying (402) the geographic location of the computing system in dependence upon the hostname series of the computing system. A hostname is a label that is assigned to a device connected to a computer network and that is used to identify the device in various forms of electronic communication such as the World Wide Web, e-mail or Usenet. Hostnames may be simple names consisting of a single word or phrase, or they may be structured. On the Internet, hostnames may have appended the name of a Domain Name System (DNS) domain, separated from the host-specific label by a period (“dot”). In the latter form, a hostname is also called a domain name. If the domain name is completely specified, including a top-level domain of the Internet, then the hostname is said to be a fully qualified domain name (FQDN). In some cases, computing systems at particular geographic locations have a common hostname. As such, one may infer the geographic location of a computing system with a particular hostname.

Also in the method of FIG. 4, identifying (302) a geographic location of a computing system may include identifying (404) the geographic location of the computing system in dependence upon a management group to which the computing system assigned. A management group as the term is used here refers to a set of computing systems that are assigned to a group through a management application and which may be managed as a group. Such a management group is often comprised of computing systems at a same geographic location. As such, one may infer the physical location of a computing system of a particular management group when one is aware of the geographic location of any of the computing systems of the particular management group.

Also in the method of FIG. 4, identifying (302) a geographic location of a computing system may include identifying (406) the geographic location of the computing system in dependence upon an Internet Protocol (‘IP’) address of the computing system. IP addresses, especially those which are exposed on the Internet, may be structured in a manner so that at least a portion of the IP address indicates a geographical location. To that end, one may infer the geographic location of the computing device by a that portion of the IP address. Further, some computing environments may be architected with many networks and subnetworks with each such network or subnetwork comprising a different range of IP addresses. In such embodiments, such networks or subnetworks may be restricted to particular data centers. Thus, one may infer the data center at which a particular computing system is installed based on the IP address of the computing system and the subnetwork or network to which that IP address belongs.

Also in the method of FIG. 4, identifying (302) a geographic location of a computing system may include identifying (408) the geographic location of the computing system in dependence upon Global Position Satellite (‘GPS’) data of the computing system. Some modern computing systems may include a GPS transceiver so that the computing system, or a device managing the computing system, may access its current location from GPS data. To that end, retrieving the current data from a GPS transceiver installed in a computing system may provide the geographic location of that computing system.

Readers of skill in the art will recognize that these are but a few of many possible example methods of identifying (302) a geographic location of a computing system. Further, any of these methods may be combined with others in an effort to identify geographic locations for many computing systems.

For further explanation, FIG. 5 sets forth a flow chart illustrating another example method for workload distribution based on serviceability according to embodiments of the present disclosure. The method of FIG. 5 is similar to the method of FIG. 2 in that the method of FIG. 5 also includes generating (202), for each of a plurality of computing systems, a metric representing serviceability of the computing system for which the metric is generated; and distributing (206) workload among said plurality of computing systems in dependence upon the metrics.

The method of FIG. 5 differs from the method of FIG. 2, however, in that generating (202), for each of a plurality of computing systems, a metric representing serviceability of the computing system for which the metric is generated includes identifying (502), for each of the plurality of computing systems, a location (508) of the computing system within a data center. Identifying (502) a location within a data center which a computing system is located may be carried out in a variety of ways. Various automatic location determination applications deployed on system management servers configured to manage computing systems in a data center may be configured to identify a rack, a row, and a location (such as a slot) within the rack of a computing system, for example. In other embodiments, a system administrator may manually input the location of a computing system within a data center.

The method of FIG. 5 continues by weighting (508) a value of the metric (204) in dependence upon the location (506) of the computing system within a data center and a ruleset (504) specifying weights for locations of computing systems within a data center. The ruleset (504) may be implemented in a manner to that described above in FIG. 3. The example ruleset (504) of FIG. 5, however, may specify an amount to adjust the value of the metric relative to the location of a computing system within a data center. For example, computing systems within racks outside of cooling zones may be more prone to failure and thus have lower serviceability than those within racks inside of cooling zones. Computing systems position in a rack further from the floor than others may be of lower serviceability and so on.

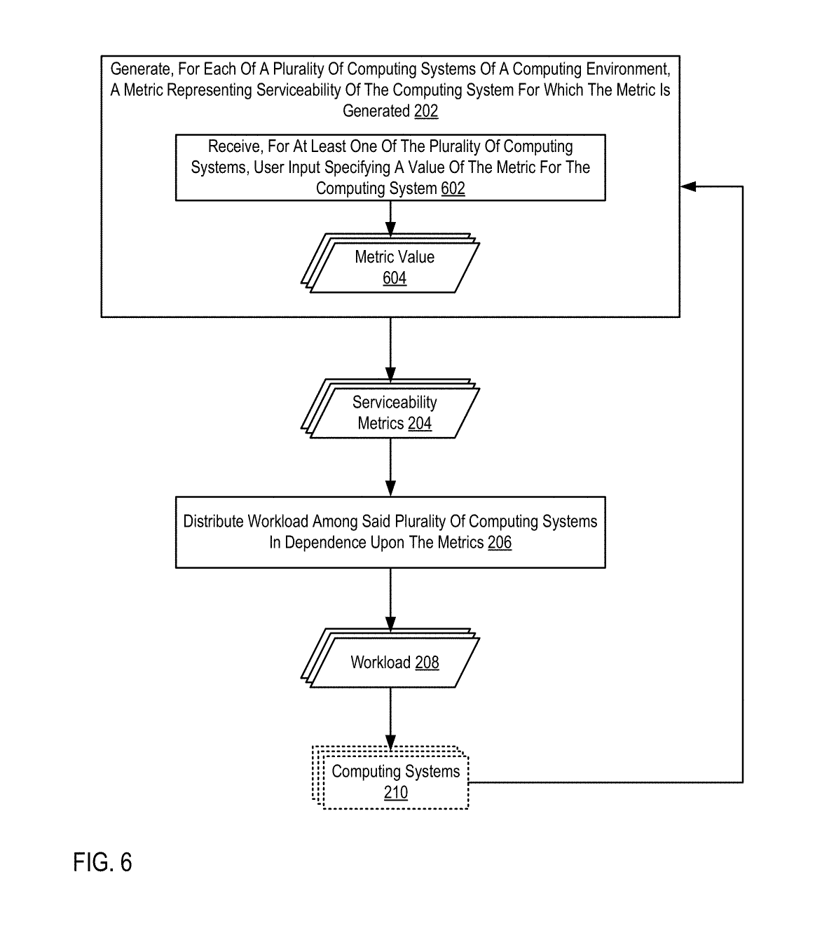

For further explanation, FIG. 6 sets forth a flow chart illustrating another example method for workload distribution based on serviceability according to embodiments of the present disclosure. The method of FIG. 6 is similar to the method of FIG. 2 in that the method of FIG. 6 also includes generating (202), for each of a plurality of computing systems, a metric representing serviceability of the computing system for which the metric is generated; and distributing (206) workload among said plurality of computing systems in dependence upon the metrics.

The method of FIG. 6 differs from the method of FIG. 2, however, in that in the method of FIG. 6, generating (202), for each of the plurality of computing systems, the metric representing serviceability of the computing system includes receiving (602), for at least one of the plurality of computing systems, user input specifying a value (604) of the metric (204) for the computing system. In some embodiments, such as when cabling of a computing system lowers the serviceability of the computing system, a system administrator or other personnel may manually input a value for the metric of the computing system. A serviceability metric generator, such as the one described above with reference to FIG. 1, may provide a user interface through which such personnel may enter serviceability metric values for various computing systems.

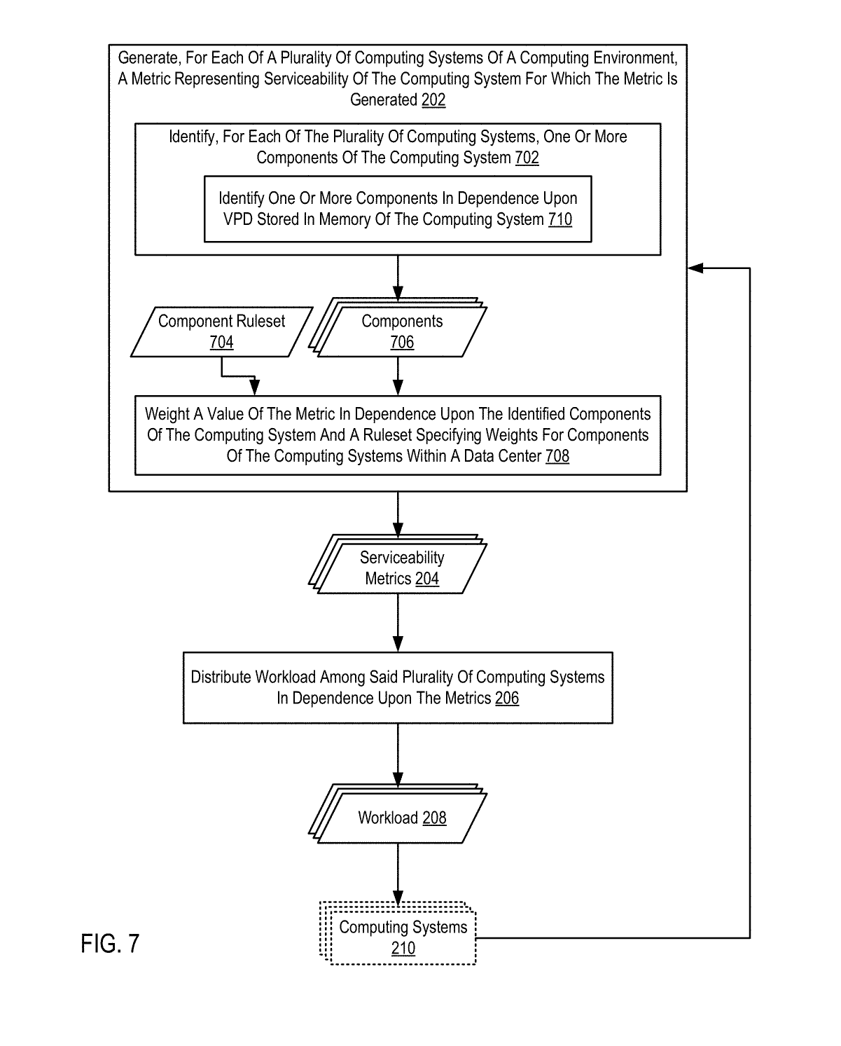

For further explanation, FIG. 7 sets forth a flow chart illustrating another example method for workload distribution based on serviceability according to embodiments of the present disclosure. The method of FIG. 7 is similar to the method of FIG. 2 in that the method of FIG. 7 also includes generating (202), for each of a plurality of computing systems, a metric representing serviceability of the computing system for which the metric is generated; and distributing (206) workload among said plurality of computing systems in dependence upon the metrics.

The method of FIG. 7 differs from the method of FIG. 2, however, in that in the method of FIG. 7 generating (202), for each of a plurality of computing systems, a metric representing serviceability of the computing system for which the metric is generated may include identifying (702), for each of the plurality of computing systems, one or more components (706) of the computing system. In the method of FIG. 7, identifying (702) one or more of components of a computing system may be carried out by identifying (710) one or more components in dependence upon vital product data (‘VPD’) stored in memory of the computing system. VPD is a collection of configuration and informational data associated with a particular set of hardware or software. VPD stores information such as part numbers, serial numbers, and engineering change levels. VPD may be stored in Flash or EEPROMs associated with various hardware components or can be queried through attached buses such as the I2C bus.

In the method of FIG. 7, generating (202) a metric representing serviceability of a computing system may also include weighting (708) a value of the metric (204) in dependence upon the identified components (706) of the computing system and a ruleset (704) specifying weights for components of the computing systems within a data center. Such a ruleset, for example, may specify weights based upon any combination of: an ability to migrate workload from the system during a service outage to avoid downtime; a cost of the components in the system; level of expertise or labor rate cost of service personnel required to perform service actions (such as locales with union requirements, locales with varying minimum wage requirements, and systems requiring higher-level servicer qualification); and cost (in terms of time, computation, or resources) to recover workload state from failure or loss of service. That is, some computing systems may be considered less serviceable than others in dependence upon the components within the computing system itself.

Readers of skill in the art will recognize that any combination of the previously described methods of generating a serviceability metric for a computing system may be combined. For example, a serviceability metric for a computing system may be generated based on a combination of: the geographic location of the computing system, the computing system's location within a data center, and the components of the computing system.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method comprising:
by first program instructions executing on a first computing system:
generating, for each of a plurality of computing systems, a metric representing serviceability of the computing system for which the metric is generated; and
distributing workload among said plurality of computing systems in dependence upon the metrics.

2. The method of claim 1 wherein generating, for each of the plurality of computing systems, the metric representing serviceability of the computing system further comprises:
identifying, for each of the plurality of computing systems, a geographic location of the computing system; and
weighting a value of the metric in dependence upon the geographic location of the computing system and a ruleset specifying weights for geographic locations.

3. The method of claim 2 wherein identifying a geographic location of the computing system includes one of:
identifying the geographic location of the computing system in dependence upon the hostname series of the computing system; identifying the geographic location of the computing system in dependence upon a management group to which the computing system assigned;
identifying the geographic location of the computing system in dependence upon an Internet Protocol (‘IP’) address of the computing system; and
identifying the geographic location of the computing system in dependence upon Global Position Satellite (‘GPS’) data of the computing system.

4. The method of claim 1 wherein generating, for each of the plurality of computing systems, the metric representing serviceability of the computing system further comprises:
identifying, for each of the plurality of computing systems, a location of the computing system within a data center; and
weighting a value of the metric in dependence upon the location of the computing system within a data center and a ruleset specifying weights for locations of computing systems within a data center.

5. The method of claim 1 wherein generating, for each of the plurality of computing systems, the metric representing serviceability of the computing system further comprises:
receiving, for at least one of the plurality of computing systems, user input specifying a value of the metric for the computing system.

6. The method of claim 1 wherein generating, for each of the plurality of computing systems, the metric representing serviceability of the computing system further comprises:
identifying, for each of the plurality of computing systems, one or more components of the computing system; and
weighting a value of the metric in dependence upon the identified components of the computing system and a ruleset specifying weights for components of the computing systems within a data center.

7. The method of claim 6 wherein identifying, for each of the plurality of computing systems, one or more components of the computing system further comprises:
identifying one or more components in dependence upon vital product data (‘VPD’) stored in memory of the computing system.

8. An apparatus comprising a computer processor and a computer memory operatively coupled to the computer processor, the computer memory including computer program instructions that, when executed by the computer processor, cause the apparatus to carry out:
generating, for each of a plurality of computing systems, a metric representing serviceability of the computing system for which the metric is generated; and
distributing workload among said plurality of computing systems in dependence upon the metrics.

9. The apparatus of claim 8 wherein generating, for each of the plurality of computing systems, the metric representing serviceability of the computing system further comprises:
identifying, for each of the plurality of computing systems, a geographic location of the computing system; and
weighting a value of the metric in dependence upon the geographic location of the computing system and a ruleset specifying weights for geographic locations.

10. The apparatus of claim 9 wherein identifying a geographic location of the computing system includes one of:
identifying the geographic location of the computing system in dependence upon the hostname series of the computing system;
identifying the geographic location of the computing system in dependence upon a management group to which the computing system assigned; identifying the geographic location of the computing system in dependence upon an Internet Protocol (‘IP’) address of the computing system; and
identifying the geographic location of the computing system in dependence upon Global Position Satellite (‘GPS’) data of the computing system.

11. The apparatus of claim 8 wherein generating, for each of the plurality of computing systems, the metric representing serviceability of the computing system further comprises:
identifying, for each of the plurality of computing systems, a location of the computing system within a data center; and
weighting a value of the metric in dependence upon the location of the computing system within a data center and a ruleset specifying weights for locations of computing systems within a data center.

12. The apparatus of claim 8 wherein generating, for each of the plurality of computing systems, the metric representing serviceability of the computing system further comprises:
receiving, for at least one of the plurality of computing systems, user input specifying a value of the metric for the computing system.

13. The apparatus of claim 8 wherein generating, for each of the plurality of computing systems, the metric representing serviceability of the computing system further comprises:
identifying, for each of the plurality of computing systems, one or more components of the computing system; and
weighting a value of the metric in dependence upon the identified components of the computing system and a ruleset specifying weights for components of the computing systems within a data center.

14. The apparatus of claim 13 wherein identifying, for each of the plurality of computing systems, one or more components of the computing system further comprises:
identifying one or more components in dependence upon vital product data (‘VPD’) stored in memory of the computing system.

15. A computer program product comprising a computer readable medium, the computer readable medium comprising computer program instructions that, when executed, cause a computer to carry out:
generating, for each of a plurality of computing systems, a metric representing serviceability of the computing system for which the metric is generated; and
distributing workload among said plurality of computing systems in dependence upon the metrics.

16. The computer program product of claim 15 wherein generating, for each of the plurality of computing systems, the metric representing serviceability of the computing system further comprises:
identifying, for each of the plurality of computing systems, a geographic location of the computing system; and
weighting a value of the metric in dependence upon the geographic location of the computing system and a ruleset specifying weights for geographic locations.

17. The computer program product of claim 16 wherein identifying a geographic location of the computing system includes one of:
identifying the geographic location of the computing system in dependence upon the hostname series of the computing system;
identifying the geographic location of the computing system in dependence upon a management group to which the computing system assigned;
identifying the geographic location of the computing system in dependence upon an Internet Protocol (‘IP’) address of the computing system; and identifying the geographic location of the computing system in dependence upon Global Position Satellite (‘GPS’) data of the computing system.

18. The computer program product of claim 15 wherein generating, for each of the plurality of computing systems, the metric representing serviceability of the computing system further comprises:
identifying, for each of the plurality of computing systems, a location of the computing system within a data center; and
weighting a value of the metric in dependence upon the location of the computing system within a data center and a ruleset specifying weights for locations of computing systems within a data center.

19. The computer program product of claim 15 wherein generating, for each of the plurality of computing systems, the metric representing serviceability of the computing system further comprises:
receiving, for at least one of the plurality of computing systems, user input specifying a value of the metric for the computing system.

20. The computer program product of claim 15 wherein generating, for each of the plurality of computing systems, the metric representing serviceability of the computing system further comprises:
identifying, for each of the plurality of computing systems, one or more components of the computing system; and
weighting a value of the metric in dependence upon the identified components of the computing system and a ruleset specifying weights for components of the computing systems within a data center.
